(19) United States
(12) Patent Application Publication
(10) Pub. No.: US 2026/0336135 A1
(43) Pub. Date: Oct. 29, 2026

(54) Interface adapter and system having a construction robot, an interface adapter and at least one power tool

(71) Applicant: Hilti Aktiengesellschaft, Schaan (LI)

(72) Inventors: Markus HARTMANN, Mauerstetten (DE); Kilian REHORIK, Wuerzburg (DE); Justus FREISCHLE, Landsberg (DE); Klaus HAUSER, Schwabmuenchen (DE); Mathias FRENZEL, Unterdiessen (DE); David WÖHRLE, Landsberg (DE); Bernd ZIEGLER, Schwabmuenchen (DE); Tobias SCHMID, Emmenhausen (DE)

(21) Appl. No.: 18/997,332

(22) PCT Filed: Jul. 21, 2023
(86) PCT No.: PCT/EP2023/070299

§ 371 Date: Jan. 21, 2025

(30) Foreign Application Priority Data
Aug. 3, 2022 (EP) 22188419.0

(51) Int. Cl. B25J 15/04; B25J 11/00; B25J 15/00; B25J 19/00

(52) U.S. Cl. CPC B25J 15/04; B25J 11/005; B25J 15/0019; B25J 19/0091

(57) ABSTRACT

An interface adapter (100) for connecting an electric power tool (10) to an end effector (222) of a construction robot (210), wherein the construction robot (210) is preferably configured for performing work on a wall and/or on a ceiling, in particular on a building construction site, on a civil engineering construction site and/or in an industrial plant, wherein the interface adapter (100) has a power tool connecting point (110) for connecting to a power tool (10), which power tool connecting point is designed complementarily to a standard storage battery interface (18) of a power tool (10). The invention also relates to a system (200) having a construction robot (210). By means of the invention, power tools (10) can be used together with a construction robot (210) in a particularly flexible manner.

The invention is concerned with the connection of an electric power tool to a construction robot.

### BACKGROUND

In order to be able to use a construction robot in as flexible and nevertheless cost-effective a manner as possible, it is desirable if the construction robot can be used together with different types of electric power tools. It would be particularly expedient if widely available and quality-tested power tools, which are relatively inexpensive by virtue of their being mass-produced, could be used together with a construction robot with little effort.

### SUMMARY OF THE INVENTION

A concern here is that conditions on construction sites are often difficult to predict and can vary from one construction site to another.

It should also be possible to carry out a wide variety of types of construction work using the construction robot, and it should accordingly be possible to use a particularly large number of different types of power tools.

It is an object of the present invention to provide a device which easily allows different types of electric power tools to be used together with a construction robot.

The present invention provides an interface adapter for connecting an electric power tool to an end effector of a construction robot, wherein the interface adapter has a connecting point for connecting to a power tool, which power tool connecting point is designed complementarily to a standard storage battery interface of a power tool.

A concept on which the invention is based here is that electric power tools, in particular storage-battery-powered power tools, for example handheld storage-battery-powered power tools, such as hand drills, in particular rock drills, nail drivers, grinding machines, power saws, chiseling machines or the like, normally have an energy supply interface which is standardized, in particular is of uniform design, at least across several types of power tool, for example from one and the same manufacturer. For example, storage-battery-powered power tools have a standard storage battery interface, by means of which a storage battery conforming to the relevant standard can be installed on the power tool. Here, the standard storage battery interface may perform at least two functions: firstly, the standard storage battery interface may be designed to securely hold the storage battery on the power tool. For this purpose, the standard storage battery interface may for example have a latching mechanism. Secondly, the standard storage battery interface may be configured for transmitting operating energy. Here, the operating energy may be transmissible unidirectionally, in particular from the storage battery to the power tool. It may also be transmissible bidirectionally, for example for the purposes of recharging the storage battery by way of recuperation. The standard storage battery interface may have yet further functions. In particular, it may also be configured for signal transmission between the storage battery and the power tool. Said signal transmission may also be unidirectional or bidirectional.

The interface adapter may thus be installed, at one side, on the end effector of the construction robot. By means of the connecting point, the interface adapter can, at the other side, be installed on the standard storage battery interface of the power tool, in particular in place of a conventional storage battery. The power tool can thus be installed on the end effector via the interface adapter. This is possible with all power tools that have the same standard storage battery interface, and thus generally with a large number of different types of power tools, in particular ones that can be powered by a storage battery.

In general, standard storage battery interfaces are designed for the fastening of a storage battery without the use of tools and/or for the dismounting of the storage battery without the use of tools. The power tool can thus also be easily and quickly separated from the end effector again, in particular without the need to use a tool.

Since such standard storage battery interfaces commonly have a latching mechanism for fixing the storage battery, it can nevertheless be ensured that the power tool is securely held on the end effector.

The construction robot may be configured for performing work on a wall and/or on a ceiling, in particular on a building construction site, on a civil engineering construction site and/or in an industrial plant.

It is conceivable that the interface adapter has a power tool signal interface and a construction robot signal interface for transmitting at least one signal between the construction robot and the power tool. Thus, in addition to a mechanical connection of the construction robot to the power tool, a signal-transmitting connection between the two devices can also be produced by means of the interface adapter.

A signal can be understood to mean at least one control signal and/or at least one sensor signal, for example.

The transmission may be unidirectional or bidirectional.

The interface adapter may also have an additional storage battery interface and/or an additional signal interface by means of which a storage battery can be attached to the interface adapter.

The power tool signal interface and the construction robot signal interface may also be configured for transmitting operating energy. Electrical operating energy can thus be supplied to the power tool. Here, operating energy can be understood to mean the energy that is substantially required for operating the power tool in the conventional manner. Correspondingly, the signal interfaces may be configured to transmit instantaneous electrical powers of at least 0.1 kW, for example of at least 1 kW.

If the interface adapter has the additional storage battery interface and/or the additional signal interface, operating energy can also be transmitted to a storage battery arranged at this or these interfaces, for example for the purposes of charging the storage battery. It can also be possible for operating energy to be transmitted away from said storage battery, for example in order to be able to briefly provide a particularly increased level of electrical power to the power tool.

At least a part of the power tool signal interface may be formed as part of the connecting point. For example, the power tool signal interface may use or at least jointly use one or more electrical contacts of the connecting point.

It can thus be possible for a sensor signal to be transmitted via the connecting point.

It is also conceivable that a separate control interface is provided for transmitting control signals, for example for activating/deactivating the power tool or for controlling at least one working parameter, for example a rotational speed. This may be expedient for example in the case of power tools in which at least one function that is required for controlling the power tool cannot be controlled via the standard storage battery interface.

The interface adapter may also comprise a signal converter that is configured to convert a signal that is received at one of the signal interfaces, for example to modify a level, an impedance and/or a signal coding of the signal, and to output said signal at the other signal interface.

It is conceivable in particular that the signal converter is configured to translate a sensor and/or control signal that has been output by the construction robot in “robot language” into a signal form that can be processed by the power tool. It is alternatively or additionally also conceivable that the signal converter is configured to convert a sensor and/or control signal from the power tool into a signal form that can be processed by the construction robot.

The construction robot can thus be rendered capable of controlling different types of power tools using signals that are in each case independent of the power tool, or conversely of receiving signals from different power tools.

Here, signals may be transmitted on a half-duplex or full-duplex basis. Said signals may be differential or ground-referenced.

It is alternatively or additionally also possible that the signal converter converts the operating energy that is to be transmitted.

The signal interfaces may be electrical interfaces. For example, provision may be made for at least one signal to be modulated upon the operating energy supply.

It is alternatively or additionally also conceivable that at least one of the signal interfaces is configured for wireless data transmission, in particular for optical and/or radio-based data transmission. For example, it is expedient if the wireless data transmission utilizes a low-energy radio standard. The connection may exhibit automatic coupling. Inductive, microwave-based and/or optical, for example infrared-based, data transmission are conceivable. Such wireless data transmission is reliable even in very dusty environments, such as are commonly encountered on construction sites. Also, such data transmission does not require any mechanical interaction for coupling purposes, thus simplifying coupling and decoupling.

The interface adapter may also have a control unit that is configured to generate a control signal and to output said control signal to at least one of the two signal interfaces.

For this purpose, the interface adapter may have a microcontroller. The microcontroller may have a memory, a microprocessor and/or program code which can be executed on the microprocessor and which is stored in the memory.

With such a control unit, the interface adapter can control the attached power tool and/or the construction robot. For example, the control unit, in particular the program code, may be configured to detect a fault, for example an incorrect arrangement of the power tool on the interface adapter. The control unit may then be configured to transmit a corresponding signal via the construction robot signal interface to the construction robot. For example, the construction robot may commence a fault handling routine in response to the signal. A further example is that the control unit of the power tool transmits an interrogation signal via the power tool signal interface. The power tool may then send back a response signal. For example, in this way, the control unit can interrogate a parameter of the power tool and/or set a parameter.

The control unit may for example be configured to interrogate a type or an identifier of the power tool. The control unit may then be configured to set a parameter of the control unit itself, for example a signal converter parameter relating to the conversion, in accordance with the type or the identifier, and/or to transmit the parameter, in this case the type or the identifier, to the construction robot via the construction robot signal interface. It is analogously also conceivable for the control unit to transmit an interrogation signal to the construction robot and to receive a response signal therefrom. Based on the response signal, the control unit may set a parameter of the control unit itself and/or of the power tool.

In particular, the control unit may be configured to receive at least one sensor signal from the power tool signal interface and/or from the construction robot signal interface. The sensor signal can then be used by the control unit for the purposes of control. For example, if the sensor signal relates to vibrations caused by the power tool, the control unit may, if a particular level of vibrations of the power tool is exceeded, transmit a control signal for working with lower power, and/or for assuming a standby mode, via the power tool signal interface. The construction robot can thus be protected against mechanical overload.

Further sensor signals are alternatively or additionally also conceivable, for example sensor signals that indicate at least one characteristic variable of the power tool and/or of the construction robot, for example with regard to vibration, current, force, temperature, power tool type, situation and/or position, a distance of travel, a feed movement and/or the like.

If the storage battery interface is available, the sensor signal may also relate to a storage battery that is connected to the storage battery interface.

It is also conceivable that the sensor signal indicates an operating mode, and/or that the control unit sets an operating mode, in particular of the power tool.

For example, the behavior of the power tool can thus be adjusted according to whether a storage battery or the interface adapter is attached. For example, depending on the state identified, a trigger may be set or ignored. Said trigger may for example initiate a wake-up mode. It is also possible for identification codes to be transmitted and/or received by the control unit.

The durability of the construction robot, and/or the precision with which construction work can be carried out, can be improved if the interface adapter has at least one damping element for damping vibrations that act on the interface adapter. The damping element may be configured for passive and/or active damping.

The interface adapter itself may have at least one sensor. The sensor may for example be a force sensor and/or a pressure sensor. The interface adapter may then be configured to measure a contact force, a pulling force and/or the like.

The invention furthermore encompasses a system comprising a construction robot, an interface adapter of the type described above and/or below, and an electric power tool, wherein the electric power tool has a standard storage battery interface, and wherein the standard storage battery interface of the power tool is arranged on the connecting point of the interface adapter.

It is conceivable that the system also comprises additional adapter parts. For example, power-tool-specific and/or construction-robot-specific adapter parts may exist. These can be used to adapt power tools and/or construction robots to the interface adapter.

The power tool may be configured to detect, in particular via its standard storage battery interface, whether a storage battery or the interface adapter is installed on the standard storage battery interface. Said power tool may also be configured to detect whether any element whatsoever is arranged on the standard storage battery interface, and if so to detect in particular what type of element it is. For example, the power tool may be configured to utilize recuperation if a storage battery is installed, and not to utilize recuperation if the interface adapter is installed.

It is also conceivable for the power tool to be modified. It is for example conceivable for a handle insert of the power tool to be at least partly exchanged for a part of the interface adapter or for the interface adapter as a whole.

The construction robot may be designed for carrying out construction work on a building construction site and/or on a civil engineering construction site and/or in an in particular steel-based industrial plant, for example on an oil platform. It may be configured for performing construction work on a ceiling, a wall and/or a floor. It may be designed for drilling, cutting-off, chiseling, grinding and/or setting a structural element. It may have one or more power tools. The power tool may comprise a cutting-off tool, a grinding tool and/or a setting tool. It is also conceivable that the end effector and/or the power tool are designed for marking. For example, the end effector may have a paint spraying device. A measuring tool, for example a distance meter, may alternatively or additionally also be arranged on the end effector.

The interface adapter may be installed on the end effector. The power tool and/or the measuring tool may in turn be installed on the interface adapter. The construction robot, in particular the end effector, may in principle also comprise multiple power tools and/or measuring tools.

The construction robot may have a manipulator. The manipulator may be designed as a robot arm. The manipulator may also have a lifting device. The lifting device may increase the size of the overall volume that can be reached by the manipulator. The manipulator may have at least three degrees of freedom. In particular, it may have at least six degrees of freedom.

The construction robot may also have a mobile platform. The mobile platform may comprise a wheeled undercarriage and/or a track-chain undercarriage. The mobile platform may have at least two degrees of freedom. The construction robot may have altogether at least ten degrees of freedom. It is alternatively also conceivable that the mobile platform is or comprises a flying platform. For example, the construction robot may also be designed as a flying drone.

Further features and advantages of the invention are apparent from the detailed description of exemplary embodiments of the invention that follows, with reference to the figures of the drawing which shows details essential to the invention, and from the claims. The features shown therein should not necessarily be considered to be true to scale and are illustrated in such a manner that the special features according to the invention can be clearly visualized. The various features can be implemented individually in their own right or collectively in any combinations in variants of the invention.

Exemplary embodiments of the invention are illustrated in the schematic drawing and elucidated in detail in the description that follows.

### BRIEF DESCRIPTION OF THE DRAWINGS

FIG. 1 shows a power tool;

FIG. 2 shows an interface adapter in a side view;

FIG. 3 shows a modified power tool having a power tool adapter part, in a side view;

FIG. 4 shows a power tool during the modification thereof, in a perspective view;

FIG. 5 shows the modified power tool having an installed interface adapter, in a side view;

FIG. 6 shows an interior view of a part of the interface adapter having a control unit, in a perspective view; and

FIG. 7 shows a system comprising a construction robot, an interface adapter and a power tool.

### DETAILED DESCRIPTION

In the description of the figures that follows, comprehension of the invention is facilitated by use of the same reference signs in each case for identical or functionally corresponding elements.

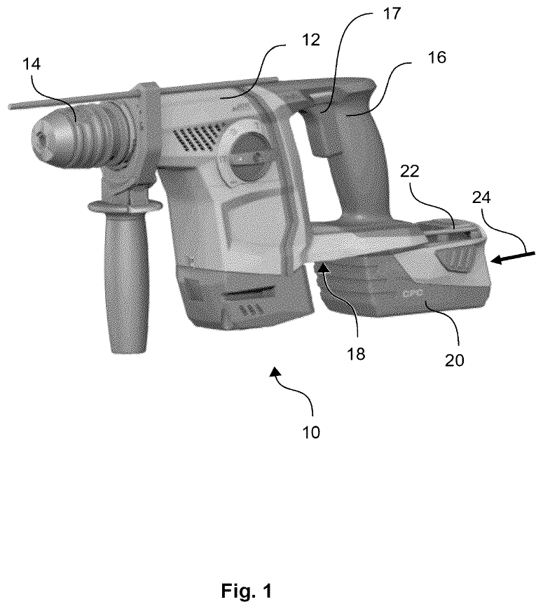

FIG. 1 shows a power tool 10. The power tool 10 is a storage-battery-powered rock drill.

Said power tool has a basic body 12, out of one end of which a tool fitting 14 projects. At the other end, said power tool has a handle 16. Situated on the handle 16 is an actuating element 17 that can be used to manually control the power tool 10. In particular, the actuating element 17 can be used to start and stop a drilling operation or to regulate a rotational speed.

Said power tool furthermore has a standard storage battery interface 18. The standard storage battery interface 18 is designed to receive storage batteries. Said standard storage battery interface serves inter alia for fixing the storage battery to the power tool 10, for transmitting operating energy between the storage battery and the power tool 10, and for transmitting signals between same.

By way of example, FIG. 1 shows a storage battery 20, which in the state shown in FIG. 1 has been pushed approximately halfway onto the standard storage battery interface 18.

In order to enable the storage battery 20 to be installed on the standard storage battery interface 18, the storage battery 20 has a connecting point 22 that is designed complementarily to the standard storage battery interface 18.

In order to be able to fully install the storage battery 20, it would have to be pushed further onto the standard storage battery interface 18 in the direction of the arrow 24. In order to be fully dismounted, the storage battery would accordingly have to be pushed further off the standard storage battery interface 18 counter to the direction of the arrow 24.

Installation and dismounting are thus possible without the use of tools.

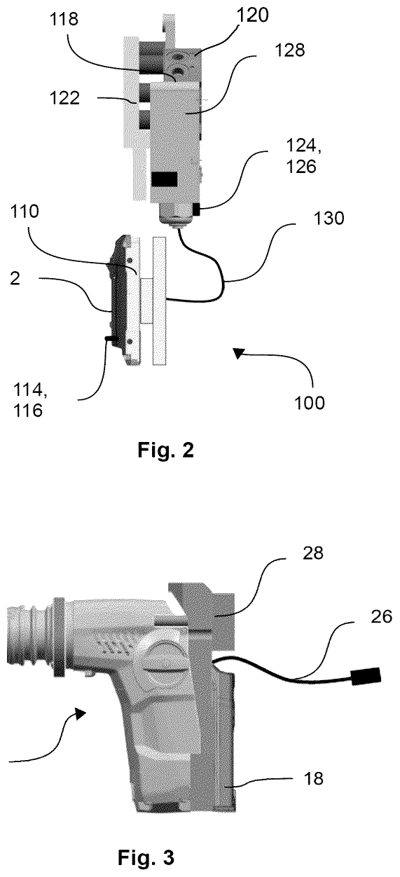

FIG. 2 shows an interface adapter 100 for connecting an electric power tool to an end effector of a construction robot.

The interface adapter has a power tool connecting point 110 for connecting to a power tool, for example the power tool 10 according to FIG. 1.

The power tool connecting point 110 has a power tool connecting portion 112 that is designed complementarily to the standard storage battery interface 18 (see FIG. 1). The power tool connecting point 110 as a whole is thus also designed complementarily to the standard storage battery interface 18.

The power tool connecting portion 112 has electrical contacts 114. If the power tool 10 has been attached to the power tool connecting point 110, operating energy, in particular for the purposes of operating the power tool 10, can be transmitted via the contacts 114. For example, provision may be made for an electrical current with a voltage of around 22 V DC voltage to be transmitted as operating energy.

It is also possible for signals to be transmitted bidirectionally from and/or to the power tool 10 via the contacts 114 by virtue of said signals being modulated upon the operating energy that is to be transmitted. The contacts 114, in conjunction with the rest of the power tool connecting point 110, thus simultaneously form a power tool signal interface 116.

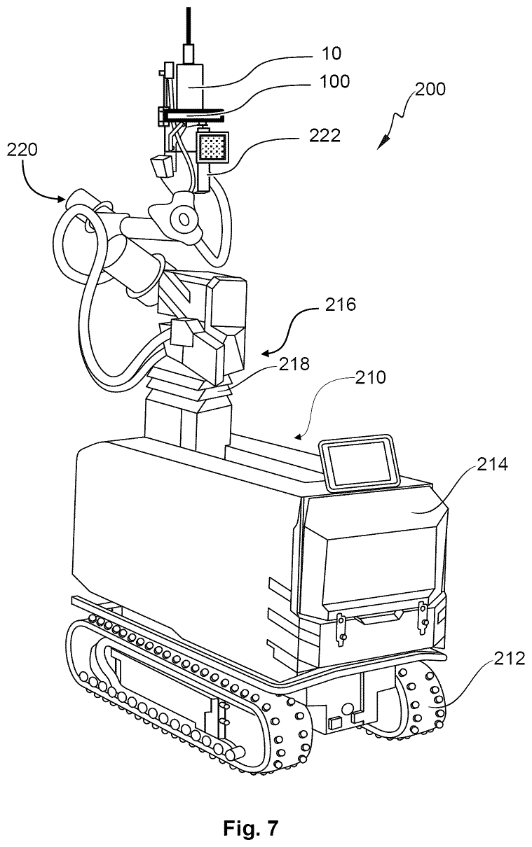

The interface adapter 100 furthermore has a construction robot connecting point 118. This serves for connecting to an end effector of a construction robot, for example to the construction robot described in more detail further below in conjunction with FIG. 7.

For the in particular releasable fastening of the interface adapter 100 to the end effector, the construction robot connecting point 118 has an in particular pneumatically actuatable bracket 120.

The power tool connecting point 110 can be pushed onto a damping element 122 such that the damping element 122 is situated substantially between the power tool connecting point 110 and the construction robot connecting point 118. Said damping element serves for damping vibrations that may originate for example from the power tool 10 during the operation thereof.

Via an electrical contact socket 124, operating energy can be transmitted between an attached construction robot and the interface adapter 100. For example, operating energy may be transmitted in the form of electrical current with a voltage of 48 V.

By modulation, it is also possible for signals to be transmitted, in particular bidirectionally, between the interface adapter 100 and the construction robot via the contact socket 124. The contact socket 124, in conjunction with the rest of the construction robot connecting point 118, thus simultaneously forms a construction robot signal interface 126.

Signals can thus be transmitted between the power tool 10 and the construction robot via the power tool signal interface 116 and via the construction robot signal interface 126.

The interface adapter 100 furthermore has a control unit 128.

The power tool connecting point 110 is electrically connected to the rest of the interface adapter 100, in particular to the control unit 128, via a connecting lead 130.

It is also thus possible for operating energy to be transmitted between the construction robot and the power tool 10 via the power tool signal interface 116 and the construction robot signal interface 126.

FIG. 3 shows the power tool 10 in a modified form. In relation to the design in FIG. 1, the handle 16 with the actuating element 17, and the storage battery 20, have been removed.

The manually operable actuating element 17 has been replaced by a control connection 26, such that the control functions of the actuating element 17 are now electronically controllable.

A power tool adapter part 28 has been installed onto the power tool 10 instead of the handle 16.

The standard storage battery interface 18 has been installed, in a pivoted position, on an outer side of the power tool adapter part 28.

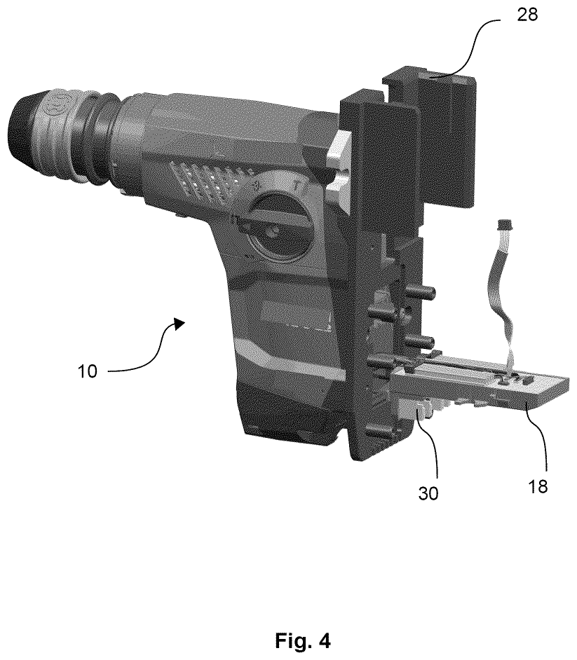

FIG. 4 shows the power tool 10 in a perspective illustration during the modification thereof. It is possible in particular to see the standard storage battery interface 18 which, in a subsequent step in relation to the illustration in FIG. 4, is to be pivoted through approximately 90° counterclockwise onto the power tool adapter part 28 that has already been installed.

It is also possible to see mating contacts 30 which are formed on the standard storage battery interface 18 and which are configured to establish electrical contact with the contacts 114 (see FIG. 2).

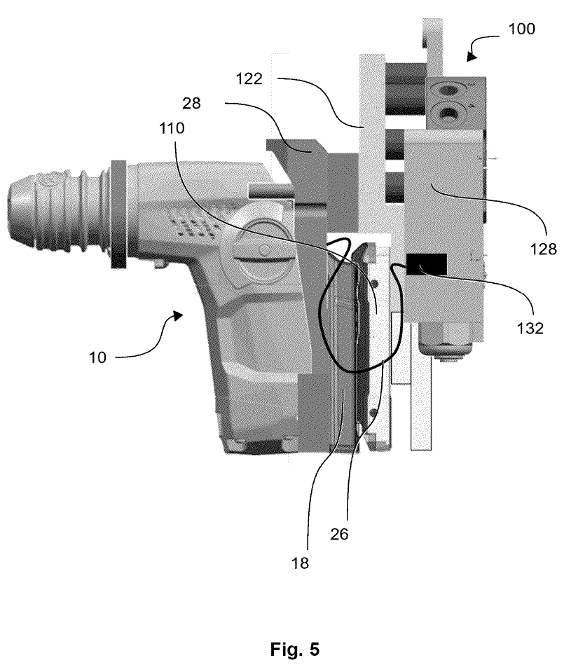

FIG. 5 shows the modified power tool 10 as per FIG. 3, onto which the interface adapter 100 according to FIG. 2 has been installed.

For this purpose, the damping element 122 has been installed, for example screwed, onto the power tool adapter part 28.

The power tool connecting point 110 is seated on the standard storage battery interface 18.

The control port 26 is connected to a control connection socket 132 of the control unit 128.

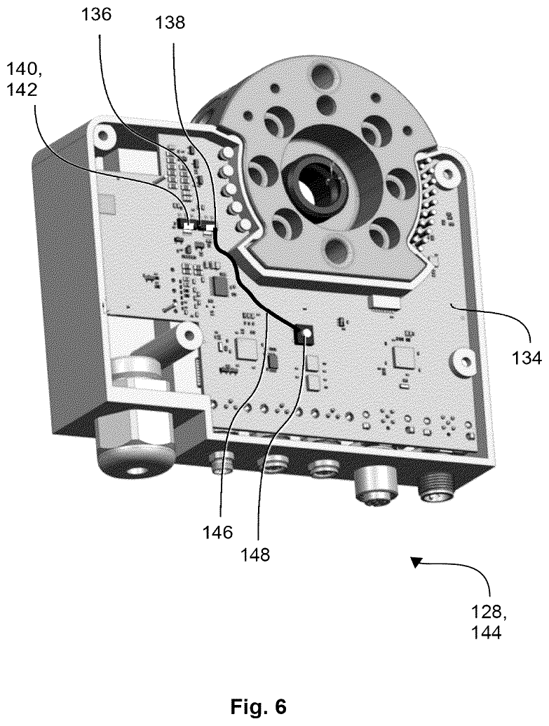

FIG. 6 shows an interior view of the control unit 128 in a perspective illustration.

The control unit 128 comprises an electronic circuit 134 which has, inter alia, a microcontroller 136. The microcontroller 136 has a microprocessor 138 and a memory 140. In the memory 140, there is stored program code 142 that can be executed on the microprocessor 138.

The control unit 128 is configured, inter alia by way of the program code 142, to convert a signal that is received at one of the signal interfaces. In particular, said control unit is configured to convert signals received at a robot signal interface 144, which have been modulated onto a direct current with a voltage of 48 V, into signals that are modulated onto a direct current with a voltage of 22 V, and to output said signals at the power tool signal interface 116. The control unit 128 thus also forms a signal converter 144.

The control unit 128 is furthermore configured, by way of the program code 142, to interrogate sensor signals 146 from a vibration sensor 148. Said control unit is furthermore configured to output a braking signal at the power tool signal interface 116 (FIG. 2) if at least one of the sensor signals 146 exceeds a threshold value. On the basis of the braking signal, the power tool 10, which in the present exemplary embodiment is configured as a rock drill, may for example reduce a rotational speed, such that the vibrations caused by said power tool also decrease.

FIG. 7 shows a system 200. The system 200 comprises a construction robot 210, an interface adapter 100, and an electric power tool 10. The interface adapter 100 corresponds to the interface adapter 100 described with reference to the preceding FIGS. 2, 5 and 6.

The power tool 10 corresponds to the power tool 10 described with reference to the preceding FIGS. 1, 3, 4 and 5.

The construction robot 210 has a mobile platform 214 equipped with a track-chain undercarriage 212. A manipulator 216 is arranged on the mobile platform 214. The manipulator 216 has a lifting device 218 on which a multi-axis arm 220 is installed. The lifting device 218 can move the arm 220 in a vertical direction. The arm 220 has at least six degrees of freedom. Thus, an end effector 222 arranged on a working end of the arm 220 can be oriented both vertically and horizontally. The construction robot 210 can thus perform construction work, in particular drilling work using the power tool 10 configured as a rock drill, on ceilings, walls and/or floors.

The interface adapter 100 is arranged on the end effector 222. The construction robot signal interface 126 (see FIG. 2) of said interface adapter is connected to a corresponding signal output of the construction robot 210.

Inter alia, the standard storage battery interface 18 (see FIG. 2) of the power tool 10 is arranged on the power tool connecting point 110 (see FIG. 2) of the interface adapter 100.

### List of Reference Signs

10 Power tool
12 Basic body
14 Tool fitting
16 Handle
17 Actuating element
18 Standard storage battery interface
20 Storage battery
22 Connecting point
24 Arrow
26 Control connection
28 Adapter part
30 Mating contact
100 Interface adapter
110 Power tool connecting point
112 Power tool connecting portion
114 Contact
116 Power tool signal interface
118 Construction robot connecting point
120 Bracket
122 Damping element
124 Contact socket
126 Construction robot signal interface
128 Control unit
130 Connecting lead
132 Control connection socket
134 Circuit
136 Microcontroller
138 Microprocessor
140 Memory
142 Program code
144 Signal converter
146 Sensor signal
148 Vibration sensor
200 System
210 Construction robot
212 Track-chain undercarriage
214 Mobile platform
216 Manipulator
218 Lifting device
220 Arm
222 End effector

What is claimed is:

1-11. (canceled)

12. An interface adapter for connecting an electric power tool to an end effector of a construction robot, the interface adapter comprising:
a power tool connecting point for connecting to a power tool, the power tool connecting point is designed complementarily to a standard storage battery interface of a power tool.

13. The interface adapter as recited in claim 12 further comprising a power tool signal interface and a construction robot signal interface for transmitting at least one signal between the construction robot and the power tool.

14. The interface adapter as recited in claim 13 wherein the power tool signal interface and the construction robot signal interface are additionally configured for transmitting operating energy.

15. The interface adapter as recited in claim 13 wherein at least a part of the power tool signal interface is formed as part of the power tool connecting point.

16. The interface adapter as recited in claim 13 further comprising a signal converter configured to convert a signal received at one of the construction robot and power tool signal interfaces and to output the signal at the other of the construction robot and power tool signal interfaces.

17. The interface adapter as recited in claim 13 wherein the signal converter modifies a level, an impedance or a signal coding of the signal,

18. The interface adapter as recited in claim 13 wherein at least one of the construction robot and power tool signal interfaces is configured for wireless data transmission.

19. The interface adapter as recited in claim 13 wherein the wireless data transmission is an optical or radio-based data transmission.

20. The interface adapter as recited in claim 13 further comprising a control unit configured to generate a control signal and to output the control signal to at least one of the construction robot and power tool signal interfaces.

21. The interface adapter as recited in claim 20 wherein the control unit is configured to receive at least one sensor signal from the power tool signal interface or from the construction robot signal interface.

22. The interface adapter as recited in claim 12 further comprising at least one damping element for damping vibrations acting on the interface adapter.

23. The interface adapter as recited in claim 12 further comprising at least one sensor.

24. The interface adapter as recited in claim 12 wherein the construction robot is a wall or a ceiling construction robot for a building construction site, on a civil engineering construction site or in an industrial plant.

25. The interface adapter as recited in claim 12 wherein the construction robot is a building construction site, civil engineering construction site or an industrial plant robot.

26. A system comprising:
a construction robot;
an interface adapter as recited in claim 12; and
an electric power tool having the standard storage battery interface arranged on the power tool connecting point of the interface adapter.
